(19) United States
(12) Patent Application Publication
(10) Pub. No.: US 2024/0209283 A1
(43) Pub. Date: Jun. 27, 2024

(54) COMPOSITION

(71) Applicant: Conopco, Inc., d/b/a UNILEVER, Englewood Cliffs, NJ (US)

(72) Inventors: Chunhui BAO, Wageningen (NL); Qin YIN, Wageningen (NL)

(73) Assignee: Conopco, Inc., d/b/a UNILEVER, Englewood Cliffs, NJ (US)

(21) Appl. No.: 18/555,554

(22) PCT Filed: May 5, 2022
(86) PCT No.: PCT/EP2022/062075

§ 371 Date: Oct. 16, 2023

(30) Foreign Application Priority Data
May 12, 2021 (WO) PCT/CN2021/093361
Jun. 24, 2021 (EP) 21181575.8

(51) Int. Cl. C11D 1/14; C11D 1/74; C11D 1/83

(52) U.S. Cl. CPC C11D 1/143; C11D 1/74; C11D 1/83

(57) ABSTRACT

A composition comprising from 30% to 100% by weight of a surfactant system which comprises an alkoxylated glycerol ester and an alkyl sulfate, wherein the weight ratio of the alkoxylated glycerol ester to the alkyl sulfate is at least 2:1.

### TECHNICAL FIELD OF THE INVENTION

The present invention relates to a composition, particularly a detergent composition comprising an alkoxylated glycerol ester and an alkyl sulfate, and related products and methods.

### BACKGROUND OF THE INVENTION

There are several instances of day-to-day activities like e.g. washing, including laundry, dishwashing and household cleaning, which require cleaning compositions. In particular, dishwashing and household cleaning include cleaning of hard surfaces like e.g. utensils, dishes, sinks, platforms, kitchen tops, tiles, floors, cupboards and doors. Typically, hard surfaces like these are cleaned by applying a hard surface cleaning composition in neat or diluted form followed by cleaning the hard surface with a suitable means like e.g. scrub, sponge, paper, cloth, wipes and simply by using hands, and rinsing the hard surface.

Surfactants are commonly used in cleaning and dishwashing compositions as detergents and wetting agents to reduce surface tension and help remove oil and greasy substances. The concentration of surfactants in a composition may be high. This is desirable for ease of transport and practicality for subsequent dilution whenever required. There are also environmental benefits associated with the reduced water content of concentrated products during transport, which reduces the size and weight of the transported products. However a high concentration of surfactants can generally be difficult to fully incorporate into the composition because such highly concentrated compositions (containing e.g less than 50 wt % water) tend to lack stability and may form a gel, rendering the product difficult or impossible to use and rendering it unappealing to the consumer. Gelation may also impact the product's efficacy in cleaning applications.

For the purposes of environmental sustainability, greener choices of surfactants may be used, especially those derived from raw materials with plant origin, such as palm oil fatty acid esters.

Surfactant compositions used in cleaning compositions are known in the art, including those comprising a type of anionic surfactant and a type of non-ionic surfactant.

U.S. Pat. No. 5,646,104 A describes a light duty liquid microemulsion composition comprising at least one anionic surfactant; a biodegradable compound; a cosurfactant; a perfume, essential oil or water insoluble hydrocarbon; and water.

EP 2666848 A1 describes aqueous, concentrated dilutable liquid cleaning compositions comprising one or more anionic surfactants, one or more non-ionic surfactants comprising polyethoxylated glycerin ester compounds, and an electrolyte, preferably in combination with one or more amphoteric surfactants, having a total active matter higher than 45 wt % based on the sum of the surfactants above that exhibit a controllable viscosity profile that is satisfactory to the consumer while being easy to dilute, providing fast enough a diluted, a medium diluted or a highly diluted cleaning composition.

U.S. Pat. No. 5,646,104 A describes a light duty liquid microemulsion composition comprises at least one anionic surfactant, a biodegradable compound, a cosurfactant, a perfume, essential oil or water insoluble hydrocarbon and water.

XP055869800 (Moragas Elisabet) describes application of POE glycerol esters in household formulas improving CLP classification.

U.S. Pat. No. 5,476,614 A describes a high foaming, surfactant based, light duty, liquid detergent with desirable cleansing properties and mildness to the human skin comprising a biodegradable solubilizing agent, a water soluble, foaming, ethoxylated alkyl ether sulfate anionic surfactant and a water soluble, foaming zwitterionic betaine surfactant.

The present invention has been devised in the light of the above considerations. It has been found unexpectedly that a composition comprising from 30% to 100% by weight of a surfactant system which comprises an alkoxylated glycerol ester and an alkyl sulfate, where the alkoxylated glycerol ester and the alkyl sulfate are present at a weight ratio of at least 2:1, provides good physical stability.

### SUMMARY OF THE INVENTION

A first aspect of the invention is a composition comprising from 30% to 100% by weight of a surfactant system which comprises:
a) an alkoxylated glycerol ester represented by the formula (I);

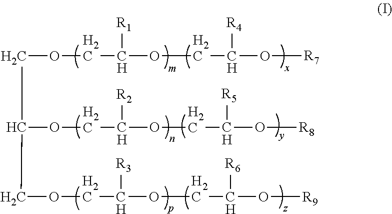

R₇=H, or —CO—R₁₀
R₈=H, or —CO—R₁₁
R₉=H, or —CO—R₁₂
   where each of R₁ to R₆ is independently a hydrogen or a methyl group; each of R₇ to R₉ is independently a hydrogen, or an acyl group in which R₁₀, R₁₁, and R₁₂ is independently a linear or branched, alkyl or alkenyl group having 1 to 30 carbon atoms; m, n, p, x, y, and z are each independently a number from 0 to 30; the sum of m, n, p, x, y, z being in the range of 1 to 90; and
b) an alkyl sulfate;
wherein the weight ratio of the alkoxylated glycerol ester to the alkyl sulfate is at least 2:1.

It has surprisingly been found that when components (a) and (b) are present in the composition at a specific weight ratio, a stable composition results which does not have the propensity to form a gel, even at high concentrations of surfactants (i.e. low water concentrations) in the composition. The composition may therefore be formulated in a more highly concentrated form while maintaining physical stability. Furthermore, the alkoxylated glycerol ester may be derived from raw materials with plant origin which is advantageous for environmental reasons.

It also has surprisingly been found that the use of an alkyl sulfate within the composition rather than alternative surfactants such as alkyl ether sulfates further reduces the occurrence of gelation.

A second aspect of the invention is a unit dose composition comprising the composition of any embodiment of the first aspect. Preferably, the unit dose compositions are packaged in water dissoluble films. More preferably, the unit dose compositions are contained within a pouch formed by a water dissoluble film.

A third aspect of the invention is a method for forming a liquid detergent composition by dispersing a dose of the composition of any embodiment of the first aspect in water. The liquid detergent composition is then suitable for use as a liquid detergent and may be diluted further in water to provide a wash liquor. Preferably, the liquid detergent composition is a liquid dishwash composition or a liquid laundry composition. More preferably, the liquid detergent composition is a liquid dishwash composition.

A fourth aspect of the invention is a method for forming a wash liquor by dispersing a dose of the composition of any embodiment of the first aspect in water.

A fifth aspect of the invention is a method of washing a hard surface comprising contacting the hard surface with a composition according to any embodiment of the first aspect. Preferably, the method of washing a hard surface comprises a method of washing dishes. The term “dish”, as used herein, includes dishes, glasses, pots, pans, baking dishes and flatware made from any material or a combination of hard surface materials commonly used in the making of articles used for eating and/or cooking.

All other aspects of the present invention will become more readily apparent upon considering the detailed description and examples which follow.

### DETAILED DESCRIPTION

Except in the examples, or where otherwise explicitly indicated, all numbers in this description indicating amounts of material or conditions of reaction, physical properties of materials and/or use may optionally be understood as modified by the word “about”.

All amounts are by weight of the final composition, unless otherwise specified. It should be noted that in specifying any ranges of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutatis mutandis.

Unless specified otherwise, amounts as used herein are expressed in percentage by weight based on the total weight of the composition and is abbreviated as “wt %” or “weight %”.

The composition may find use in a variety of cleaning applications. In some embodiments the composition is a laundry detergent composition. The term “laundry detergent” in the context of this invention denotes formulated compositions intended for and capable of wetting and cleaning domestic laundry such as clothing, linens and other household textiles. Examples of liquid laundry detergents include heavy-duty liquid laundry detergents for use in the wash cycle of automatic washing machines, as well as liquid fine wash and liquid colour care detergents such as those suitable for washing delicate garments (e.g. those made of silk or wool) either by hand or in the wash cycle of automatic washing machines. In preferred embodiments the composition is handwash detergents which involve the consumer using their hands to wash substrates. Fields of use principally involve laundry use (i.e. the hand washing of clothes) and hand dishwash (i.e. the hand washing of dishes and the like). Handwash detergents involve intimate contact of the detergent liquor with the hands during the washing process, whether in laundry or hand dishwash. Dishwash detergent composition is particularly preferred.

The present invention relates to a composition comprising from 30% to 100% by weight of a surfactant system which comprises a) an alkoxylated glycerol ester according to formula (I) and b) an alkyl sulfate, wherein the weight ratio of the alkoxylated glycerol ester to the alkyl sulfate is at least 2:1.

### Alkoxylated Glycerol Ester

The alkoxylated glycerol ester is represented by the formula (I);

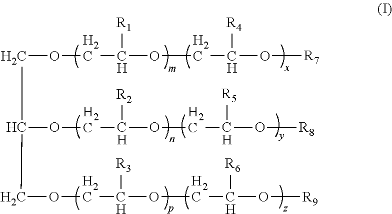

R₇=H, or —CO—R₁₀
R₈=H, or —CO—R₁₁
R₉=H, or —CO—R₁₂
where each of R₁ to R₆ is independently a hydrogen or a methyl group; each of R₇ to R₉ is independently a hydrogen, or an acyl group in which R₁₀, R₁₁, and R₁₂ is independently a linear or branched, alkyl or alkenyl group having 1 to 30 carbon atoms; m, n, p, x, y, and z are each independently a number from 0 to 30; the sum of m, n, p, x, y, z being in the range of 1 to 90.

In some embodiments, R₁, R₂ and R₅ are each hydrogen. In some embodiments, R₄, R₅ and R₆ are each hydrogen. In some embodiments, each of R₁ to R₆ is hydrogen.

In some embodiments, each of R₇ to R₉ is independently a hydrogen, or an acyl group in which R₁₀, R₁₁, and R₁₂ is independently a linear alkyl or alkenyl group having 1 to 30 carbon atoms, preferably from 7 to 21 carbon atoms, more preferably from 11 to 17 carbon atoms. In some embodiments, each of R₇ to R₉ is independently a hydrogen, or an acyl group in which R₁₀, R₁₁, and R₁₂ is independently a linear alkyl group having 1 to 30 carbon atoms, preferably from 7 to 21 carbon atoms, more preferably from 11 to 17 carbon atoms

In some embodiments, R₇, R₈ and R₉ are the same as one another. In other embodiments, R₇, R₈ and R₉ differ from one another. In some embodiments, one of R₇, R₈ and R₉ differs from the remaining groups of R₇, R₈ and R₉.

Preferably, each of R₁ to R₆ is hydrogen, and each of R₇ to R₉ is an acyl group in which R₁₀, R₁₁, and R₁₂ is independently a linear or branched, alkyl or alkenyl group having 1 to 30 carbon atoms, more preferably from 7 to 21 carbon atoms, most preferably from 11 to 17 carbon atoms. More preferably, each of R₁ to R₆ is hydrogen, and each of R₇ to R₉ is an acyl group in which R₁₀, R₁₁, and R₁₂ is independently a linear alkyl group having 1 to 30 carbon atoms, more preferably from 7 to 21 carbon atoms, most preferably from 11 to 17 carbon atoms.

Preferably, m, n, p, x, y, and z are each independently a number from 1 to 25 and more preferably from 3 to 16. Preferably, the sum of m, n, p, x, y, z is in the range of 3 to 60, more preferably from 30 to 40. Preferably, the alkoxylated glycerol ester is ethoxylated glycerol ester with R₇ to R₉ each independently selected from an acyl group in which R₁₀, R₁₁, and R₁₂ is independently a linear alkyl group having 7 to 21 carbon atoms, more preferably 11 to 17 carbon atoms.

Preferably, the alkoxylated glycerol ester comprises coconut oil ethoxylates. Coconut oil include around 82 wt % saturated fatty acids and of the total fatty acid content lauric acid is the most common at around 48 wt % of the fatty acid content. Myristic acid (16 wt %) and palmitic acid (9.5% wt.) are the next most common. Oleic acid is the most common unsaturated acid present at around 6.5% wt. of the fatty acid content.

Preferably, the alkoxylated glycerol ester comprises palm oil ethoxylates. Palm oil has a balanced fatty acid composition in which the level of saturated fatty acids is almost equal to that of the unsaturated fatty acids. Palmitic acid (44%-45%) and oleic acid (39%-40%) are the major component acids, with linoleic acid (10%-11%) and only a trace amount of linolenic acid. Palm kernel oil contains more saturated fatty acids compared to palm oil. The major fatty acids in palm kernel oil are about 48% lauric acid, 16% myristic acid and 15% oleic acid. The most preferred alkoxylated glycerol ester is palm kernel oil ethoxylates. An example is commercially available under the trade name SOE-N-60 from Sinolight Surfactant Technology Co., Ltd.

Other suitable alkoxylated glyceryl esters are commercially available from Kao under the Levenol brand name. Variants such as Levenol F-200 which has an average ethylene oxide (EO) of 6 and a molar ratio between glycerol and coco fatty acid of 0.55, Levenol V501/2 which has an average EO of 17 and a molar ratio between glycerol and coco fatty acid of 1.5 and Levenol C201 which is also known as glycereth-17 cocoate.

Typically, the amount of alkoxylated glycerol ester employed in the composition is in the range of from 0.1% to 99%, more preferably from 1 to 90%, more preferably still from 5 to 80%, even more preferably from 10 to 70% and most preferably from 20 to 60%, based on total weight of the composition and including all ranges subsumed therein.

### Alkyl Sulfate

Alkyl sulfates are anionic surfactants which are water-soluble salts containing a hydrocarbon hydrophobic group and a hydrophilic sulfate group.

In some embodiments, the alkyl sulfate has an alkyl group having 8 to 18 carbon atoms, preferably from 10 to 18 carbon atoms. It will be appreciated that both branched and straight chained alkyl groups are encompassed. The alkyl substituent is preferably linear, i.e. normal alkyl, however, branched chain alkyl sulfates can be employed, although they are less preferred from a biodegradability perspective.

In some embodiments, the alkyl sulfate comprises a salt of an alkyl sulfate, for example a metal salt of an alkyl sulfate. In this way, the alkyl sulfate comprises a positively charged ion (e.g. metal ion or organic cation such as ammonium) and a negatively charged alkyl sulfate moiety. The ion may be an alkali metal ion, an alkaline earth metal ion or a transition metal ion. Preferably the ion is an alkali metal ion.

In some embodiments, the alkyl sulfate comprises a metal salt of a C₈-C₁₈ alkyl sulfate, preferably a C₁₀-C₁₈ alkyl sulfate, such as a C₁₀-C₁₆ alkyl sulfate. In some embodiments, the alkyl sulfate comprises a metal salt of a C₈-C₁₈ linear alkyl sulfate, preferably a C₁₀-C₁₈ linear alkyl sulfate, such as a C₁₀-C₁₆ linear alkyl sulfate. In some embodiments, the alkyl sulfate comprises an alkali metal salt of a C₈-C₁₈ alkyl sulfate, preferably a C₁₀-C₁₈ alkyl sulfate, such as a C₁₀-C₁₆ alkyl sulfate. In some embodiments, the alkyl sulfate comprises an alkali metal salt of a C₈-C₁₈ linear alkyl sulfate, preferably a C₁₀-C₁₈ linear alkyl sulfate, such as a C₁₀-C₁₆ linear alkyl sulfate. In some embodiments, the alkyl sulfate comprises a sodium salt of a C₈-C₁₈ alkyl sulfate, preferably a C₁₀-C₁₈ alkyl sulfate, such as a C₁₀-C₁₆ alkyl sulfate. In some embodiments, the alkyl sulfate comprises a sodium salt of a C₈-C₁₈ linear alkyl sulfate, preferably a C₁₀-C₁₈ linear alkyl sulfate, such as a C₁₀-C₁₆ linear alkyl sulfate. Preferably, the alkyl sulfate comprises a C₁₂ alkyl sulfate, for example a metal salt of a C₁₂ alkyl sulfate, such as a sodium salt of a C₁₂ alkyl sulfate.

It is preferred that the alkyl sulfate comprises sodium, magnesium, ammonium or ethanolamine salts of alkyl sulfate having 8 to 18 carbon atoms. Illustrative examples of alkyl sulfates include sodium lauryl sulfate (also known as sodium dodecyl sulfate), ammonium lauryl sulfate, soap, diethanolamine (DEA) lauryl sulfate. Suitable examples also include alkyl sulfates commercially available from natural source with trade names Galaxy 689, Galaxy 780, Galaxy 789, Galaxy 799 SP and from synthetic origin with trade names Safol 23, Dobanol 23A or 23S, Lial 123 S, Alfol 1412S, Empicol LC3, Empicol 075SR.

Sodium lauryl sulfate (SLS), also known as sodium dodecyl sulfate, is particularly preferred as the alkyl sulfate.

Typically, the amount of alkyl sulfate employed in the composition is in the range of from 0.1% to 60%, more preferably 1% to 30%, more preferably still from 3 to 25% and most preferably from 5 to 20%, based on total weight of the composition and including all ranges subsumed therein.

### Surfactant System

It will be understood that “surfactant system”, as used herein, means the total surfactant content of the composition. The surfactant system is present at a level of from 30 to 100%, preferably from 35 to 95%, more preferably still from 35 to 90%, even more preferably from 40 to 90% and most preferably from 45 to 80%, based on total weight of the composition and including all ranges subsumed therein.

The surfactant system comprises the alkoxylated glycerol ester represented by the formula (I) and the alkyl sulfate. In some embodiments, the surfactant system comprises more than one type of alkoxylated glycerol ester compound, wherein all alkoxylated glycerol ester compounds in the surfactant system are represented by the formula (I). For example, the surfactant system may comprise multiple alkoxylated glycerol ester compounds having a distribution of chain lengths at the groups represented by R₇, R₈ and R₉ in formula (I).

In some embodiments, the surfactant system comprises one or more alkoxylated glycerol esters represented by the formula (I); and one or more alkyl sulfates. In some embodiments, the surfactant system consists of one or more alkoxylated glycerol esters represented by the formula (I); and one or more alkyl sulfates.

It is preferred that the alkoxylated glycerol ester is present in an amount of from 20% to 99%, more preferably from 30% to 95%, more preferably still from 40% to 90%, and most preferably from 50 to 90%, based on total weight of the surfactant system and including all ranges subsumed therein.

It is preferred that the alkyl sulfate is present in an amount of from 1 to 40%, more preferably from 3 to 35%, more preferably still from 5 to 35% and most preferably from 5 to 30%, based on total weight of the surfactant system and including all ranges subsumed therein.

Preferably, the alkoxylated glycerol ester and the alkyl sulfate together make up at least 50% of the surfactant system, more preferably from 60% to 100%, more preferably still from 65 to 95% and most preferably from 70 to 90%, based on total weight of the surfactant system and including all ranges subsumed therein. It is also preferred that the alkoxylated glycerol ester and the alkyl sulfate together make up 100 wt % of the surfactant system.

The weight ratio of the alkoxylated glycerol ester to the alkyl sulfate is at least 2:1, preferably from 2.5:1 to 50:1, more preferably from 3:1 to 40:1, more preferably still from 5:1 to 40:1 and most preferably from 5:1 to 30:1.

The surfactant system may also comprise other surfactants in addition to the alkoxylated glycerol ester and the alkyl sulfate.

A preferred class of anionic surfactant may be used in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ. Examples of alkylbenzene sulfonates include sodium salt of linear alkylbenzene sulphonate, alkyl toluene sulphonate, alkyl xylene sulphonate, alkyl phenol sulphonate, alkyl naphthalene-sulphonate, ammonium diamylnaphthalene-sulphonate and sodium dinonylnaphthalene-sulphonate and mixtures with olefin sulphonates.

Another anionic surfactant commonly used in compositions are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 2EO units per molecule.

Alkyl ether sulfates may be present in the composition. Preferably, the composition is substantially free of alkyl ether sulfates. “Substantially free of”, as used herein, means less than 1.5%, preferably less than 1.0%, more preferably less than 0.75%, more preferably still less than 0.5% and even more preferably less than 0.1% and most preferably from 0 to 0.01% by weight, based on total weight of the composition, including all ranges subsumed therein. It is preferred that the composition does not comprise any alkyl ether sulfates.

When the composition comprises anionic surfactants in addition to the alkyl sulfate, the anionic surfactant is typically present at a level from 0.01 to 10%, more preferably from 0.1 to 5% and most preferably from 0.5 to 5%, based on total weight of the composition and including all ranges subsumed therein.

The surfactant system may also comprise other non-ionic surfactant in addition to the alkoxylated glycerol ester represented by formula (I).

Non-ionic surfactants in addition to the alkoxylated ester surfactants may be included in the surfactant system of the composition. Non-ionic surfactants are characterized by the presence of a hydrophobic group and an organic hydrophilic group and are typically produced by the condensation of an organic aliphatic or alkyl aromatic hydrophobic compound with ethylene oxide (hydrophilic in nature). Typical suitable non-ionic surfactants are those disclosed in U.S. Pat. Nos. 4,316,812 and 3,630,929, incorporated by reference herein.

Usually, the non-ionic surfactants are polyalkoxylated lipophiles wherein the desired hydrophile-lipophile balance is obtained from addition of a hydrophilic poly-alkoxy group to a lipophilic moiety. A preferred class of non-ionic detergent is the alkoxylated alkanols wherein the alkanol is of 9 to 20 carbon atoms and wherein the number of moles of alkylene oxide (of 2 or 3 carbon atoms) is from 3 to 20. Of such materials it is preferred to employ those wherein the alkanol is a fatty alcohol of 9 to 11 or 12 to 15 carbon atoms and which contain from 5 to 9 or 5 to 12 alkoxy groups per mole. Also preferred is paraffin-based alcohol (e.g. non-ionics from Huntsman or Sasol).

Exemplary of such compounds are those wherein the alkanol is of 10 to 15 carbon atoms and which contain about 5 to 12 ethylene oxide groups per mole, e.g. Neodol 25-9 and Neodol 23-6.5, which products are made by Shell Chemical Company, Inc. The former is a condensation product of a mixture of higher fatty alcohols averaging about 12 to 15 carbon atoms, with about 9 moles of ethylene oxide and the latter is a corresponding mixture wherein the carbon atoms content of the higher fatty alcohol is 12 to 13 and the number of ethylene oxide groups present averages about 6.5. The higher alcohols are primary alkanols.

In the compositions of this invention, preferred non-ionic surfactants include the C12-C15 primary fatty alcohols with relatively narrow contents of ethylene oxide in the range of from about 3 to 20 moles, more preferably from 3 to 10 moles of ethylene oxide per mole of alcohol. Particularly preferred are lauryl alcohol condensed with 3, 5, 7 and 9 moles of EO (AEO-3, AEO-5, AEO-7 and AEO-9).

Another class of non-ionic surfactants which can be used in accordance with this invention are glycoside surfactants. Glycoside surfactants suitable for use in accordance with the present invention include those of the formula:

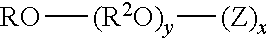

wherein R is a monovalent organic radical containing from about 6 to about 30 (preferably from about 8 to about 18) carbon atoms; R² is a divalent hydrocarbon radical containing from about 2 to 4 carbons atoms; O is an oxygen atom; y is a number which can have an average value of from 0 to about 12 but which is most preferably zero; Z is a moiety derived from a reducing saccharide containing 5 or 6 carbon atoms; and x is a number having an average value of from 1 to about 10 (preferably from about 1½ to about 10).

A particularly preferred group of glycoside surfactants for use in the practice of this invention includes those of the formula above in which R is a monovalent organic radical (linear or branched) containing from about 6 to about 18 (especially from about 8 to about 18) carbon atoms; y is zero; z is glucose or a moiety derived therefrom; x is a number having an average value of from 1 to about 4 (preferably from about 1½ to 4).

Another preferred class of non-ionic surfactant for use in the invention includes fatty acid amides. Preferably, the fatty acid amide contains at least 6 carbon atoms. Suitable fatty acid preferably contains from 8 to 24 carbon atoms, preferably from 12 to 20 carbon atoms, and most preferably from 12 to 18 carbon atoms. In the most preferred embodiment of the invention, amides of essential fatty acids are employed. Amides suitable for use in the present invention may be simple amides (i.e., those containing a —CONH₂ group), N-alkyl amides, N, N-dialkyl amides, mono-alkanol amides, and di-alkanol amides. Suitable alkyl or alkanol groups contain from 1 to 30 carbon atoms, preferably from 1 to 20 carbon atoms, and most preferably from 1 to 8 carbon atoms. The preferred amides included in the present invention are mono- and di-alkanol amides, particularly of essential fatty acids. Alkanol amides are more commonly available than alkyl amides.

Preferably, the fatty acid amide is fatty alkanolamides (fatty acid alkanolamides), more preferably C₈ to C₂₀ fatty acid C₁ to C₈ alkanolamide. The preferred fatty acid amides are selected from mono- and diethanolamides of linoleic acid, palmitic acid, and coconut oil. More preferably the fatty acid amide comprises cocamide MEA, cocamide DEA, lauramide DEA, palm kernelamide DEA, stearamide MEA, myristamide DEA, stearamide DEA, oleylamide DEA, tallowamide DEA, tallowamide MEA, isostearamide DEA, isostearamide MEA, cocamide MIPA, or a mixture thereof. Palm kernelamide DEA is particularly preferred.

Non-ionic surfactants which may be used include polyhydroxy amides as discussed in U.S. Pat. No. 5,312,954 to Letton et al. and aldobionamides such as disclosed in U.S. Pat. No. 5,389,279 to Au et al., both of which are hereby incorporated by reference into the subject application. Another preferred class of non-ionic surfactant is rhamnolipids.

Mixtures of two or more of the non-ionic surfactants can be used. When the composition comprises non-ionic surfactants in addition to the alkoxylated glycerol ester, the non-ionic surfactant is typically present at a level from 0 to 10%, more preferably from 0 to 5% and most preferably from 0 to 3%, based on total weight of the composition and including all ranges subsumed therein.

The surfactant system may also comprise one or more types of cationic surfactant. Many cationic surfactants are known in the art, and almost any cationic surfactant having at least one long chain alkyl group of about 10 to 24 carbon atoms may be present as an auxiliary component of the surfactant system. Such compounds are described in “Cationic Surfactants”, Jungermann, 1970, incorporated by reference.

Specific cationic surfactants include C8 to C18 alkyl dimethyl ammonium halides and derivatives thereof in which one or two hydroxyethyl groups replace one or two of the methyl groups, and mixtures thereof. More cationic surfactants which can be used as surfactants are described in detail in U.S. Pat. No. 4,497,718, hereby incorporated by reference. As with the non-ionic and anionic surfactants, the compositions of the invention may use cationic surfactants alone or in combination with any of the other surfactants known in the art. Cationic surfactant, when included, may be present in an amount ranging from 0 to 5% based on total weight of the composition. It is preferred that the composition does not comprise any cationic surfactants.

The surfactant system may also comprise one or more types of amphoteric surfactant. Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0 to 5% based on total weight of the composition. It is preferred that the composition does not comprise any amphoteric surfactants.

### Carrier

The present invention has a surfactant system comprising alkoxylated glycerol ester represented by formula (I) and alkyl sulfate. The surfactant system is between 30 wt % to 100 wt % of the total composition. When the surfactant system is less than 100% of the total composition, the remaining weight % may generally comprise water as a carrier. Preferably the composition comprises from 0% to 70%, preferably 7% to 70%, most preferably, 20% to 70% water.

In some embodiments, the composition consists of the surfactant system and water.

The composition may be concentrated or dilute. A “dilute” composition refers to a composition comprising greater than 50 wt % water based on the total composition weight, for example greater than 60 wt %, greater than 70 wt % or greater than 80 wt %. Preferably, the composition is a concentrated composition. A “concentrated” composition refers to a composition comprising up to 50 wt % water based on the total composition weight, for example up to 40 wt %, up to 30 wt % or up to 20 wt %. The advantages of reduced gelation of the composition due to the 2:1 ratio of components (a) and (b) are particularly evident in the case of concentrated compositions, which would otherwise be more susceptible to gelation.

The composition of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included, may be present in an amount ranging from 0.1 to 20%, preferably from 2 to 15%, and more preferably from 10 to 14% based on total weight of the composition and including all ranges subsumed therein. The level of hydrotrope used is linked to the level of surfactant and it is desirable to use hydrotrope level to manage the viscosity in such compositions. The preferred hydrotropes are monopropylene glycol and glycerol.

### Other Ingredients

The composition may also contain one or more chelating agents for transition metal ions. Such chelating agents may also have calcium and magnesium chelation capacity, but preferentially bind heavy metal ions such as iron, manganese and copper. Such chelating agents may help to improve the stability of the composition and protect for example against transition metal catalyzed decomposition of certain ingredients.

Suitable transition metal ion chelating agents include phosphonates, in acid and/or salt form. When utilized in salt form, alkali metal (e.g. sodium and potassium) or alkanolammonium salts are preferred. Specific examples of such materials include aminotris(methylene phosphonic acid) (ATMP), 1-hydroxyethylidene diphosphonic acid (HEDP) and diethylenetriamine penta(methylene phosphonic acid (DTPMP) and their respective sodium or potassium salts. HEDP is preferred. Mixtures of any of the above described materials may also be used.

Transition metal ion chelating agents, when included, may be present in an amount ranging from about 0.1 to about 10%, preferably from about 0.1 to about 3%, based on total weight of the composition and including all ranges subsumed therein.

The composition may also comprise an effective amount of one or more enzyme selected from the group comprising, pectate lyase, protease, amylase, cellulase, lipase, mannanase and mixtures thereof. The enzymes are preferably present with corresponding enzyme stabilizers.

The composition may contain further optional ingredients to enhance performance and/or consumer acceptability. Examples of such ingredients include foam control agents, preservatives (e.g. bactericides), fluorescers and pearlisers. Each of these ingredients will be present in an amount effective to accomplish its purpose. Generally, these optional ingredients are included individually at an amount of up to 5% based on total weight of the composition.

### Packaging and Dosing

The composition may be formulated into any suitable physical form, including powders, granulates, tablets, liquids, etc. Preferably, the composition is provided in a liquid form. More preferably the composition is a highly concentrated liquid laundry or liquid dishwash composition.

A composition of the invention may be packaged as unit doses in polymeric film soluble in the wash water. The unit dose composition of the invention is contained within a pouch formed by a water dissoluble film.

Such water-soluble film compositions, optional ingredients for use therein, and methods of making the same are well known in the art, whether being used for making relatively thin water-soluble films (e.g., as pouch materials) or otherwise.

In one class of embodiments, the water-soluble film includes a water dissoluble material. Preferred such materials include polyvinyl alcohol (PVOH), including homopolymers thereof (e.g., including substantially only vinyl alcohol and vinyl acetate monomer units) and copolymers thereof (e.g., including one or more other monomer units in addition to vinyl alcohol and vinyl acetate units). PVOH is a synthetic resin generally prepared by the alcoholysis, usually termed hydrolysis or saponification, of polyvinyl acetate. Fully hydrolyzed PVOH, wherein virtually all the acetate groups have been converted to alcohol groups, is a strongly hydrogen-bonded, highly crystalline polymer which dissolves only in hot water-greater than about 140 degrees Fahrenheit (60 degrees C.). If a sufficient number of acetate groups are allowed to remain after the hydrolysis of polyvinyl acetate, the PVOH polymer then being known as partially hydrolyzed, it is more weakly hydrogen-bonded and less crystalline and is soluble in cold water-less than about 50 degrees Fahrenheit (10 degrees C.). An intermediate cold or hot water soluble film can include, for example, intermediate partially-hydrolyzed PVOH (e.g., with degrees of hydrolysis of about 94 percent to about 98 percent), and is readily soluble only in warm water—e.g., rapid dissolution at temperatures of about 40 degrees centigrade and greater. Both fully and partially hydrolyzed PVOH types are commonly referred to as PVOH homopolymers although the partially hydrolyzed type is technically a vinyl alcohol-vinyl acetate copolymer.

The degree of hydrolysis (DH) of the PVOH polymers and PVOH copolymers included in the water-soluble films of the present disclosure can be in a range of about 75 percent to about 99 percent (e.g., about 79 percent to about 92 percent, about 86.5 percent to about 89 percent, or about 88 percent, such as for cold-water soluble compositions; about 90 percent to about 99 percent, about 92 percent to about 99 percent, or about 95 percent to about 99 percent). As the degree of hydrolysis is reduced, a film made from the resin will have reduced mechanical strength but faster solubility at temperatures below about 20 degrees centigrade As the degree of hydrolysis increases, a film made from the polymer will tend to be mechanically stronger and the thermoformability will tend to decrease. The degree of hydrolysis of the PVOH can be chosen such that the water-solubility of the polymer is temperature dependent, and thus the solubility of a film made from the polymer, any compatibilizer polymer, and additional ingredients is also influenced. In one option the film is cold water-soluble. A cold water-soluble film, soluble in water at a temperature of less than 10 degrees centigrade, can include PVOH with a degree of hydrolysis in a range of about 75 percent to about 90 percent, or in a range of about 80 percent to about 90 percent, or in a range of about 85 percent to about 90 percent. In another option the film is hot water-soluble. A hot water-soluble film, soluble in water at a temperature of at least about 60 degrees centigrade, can include PVOH with a degree of hydrolysis of at least about 98 percent.

Other water soluble polymers for use in addition to the PVOH polymers and PVOH copolymers in the blend can include, but are not limited to modified polyvinyl alcohols, polyacrylates, water-soluble acrylate copolymers, polyvinyl pyrrolidone, polyethyleneimine, pullulan, water-soluble natural polymers including, but not limited to, guar gum, gum Acacia, xanthan gum, carrageenan, and starch, water-soluble polymer derivatives including, but not limited to, modified starches, ethoxylated starch, and hydroxypropylated starch, copolymers of the forgoing and combinations of any of the foregoing. Yet other water-soluble polymers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, and polymethacrylates. Such water-soluble polymers, whether PVOH or otherwise are commercially available from a variety of sources. Any of the foregoing water-soluble polymers are generally suitable for use as film-forming polymers. In general, the water-soluble film can include copolymers and/or blends of the foregoing resins.

The water-soluble polymers (e.g., the PVOH resin blend alone or in combination with other water-soluble polymers) can be included in the film in an amount in a range of about 30 weight percent or 50 weight percent to about 90 weight percent or 95 weight percent, for example. The weight ratio of the amount of all water-soluble polymers as compared to the combined amount of all plasticizers, compatibilizing agents, and secondary additives can be in a range of about 0.5 to about 18, about 0.5 to about 15, about 0.5 to about 9, about 0.5 to about 5, about 1 to 3, or about 1 to 2, for example. The specific amounts of plasticizers and other non-polymer component can be selected in a particular embodiment based on an intended application of the water-soluble film to adjust film flexibility and to impart processing benefits in view of desired mechanical film properties.

Water-soluble polymers for use in the film described herein (including, but not limited to PVOH polymers and PVOH copolymers) can be characterized by a viscosity in a range of about 3.0 to about 27.0 cP, about 4.0 to about 24.0 cP, about 4.0 to about 23.0 cP, about 4.0 cP to about 15 cP, or about 6.0 to about 10.0 cP, for example. The viscosity of a polymer is determined by measuring a freshly made solution using a Brookfield LV type viscometer with UL adapter as described in British Standard EN ISO 15023-2:2006 Annex E Brookfield Test method. It is international practice to state the viscosity of 4 percent aqueous polyvinyl alcohol solutions at 20 degrees centigrade Polymeric viscosities specified herein in cP should be understood to refer to the viscosity of a 4 percent aqueous water-soluble polymer solution at 20 degrees centigrade, unless specified otherwise.

It is well known in the art that the viscosity of a water-soluble polymer (PVOH or otherwise) is correlated with the weight-average molecular weight (W) of the same polymer, and often the viscosity is used as a proxy for Mw. Thus, the weight-average molecular weight of the water-soluble polymers, including the first PVOH copolymer and second PVOH polymer, can be in a range of about 30,000 to about 175,000, or about 30,000 to about 100,000, or about 55,000 to about 80,000, for example.

The water-soluble film can contain other auxiliary agents and processing agents, such as, but not limited to, plasticizers, plasticizer compatibilizers, surfactants, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. Embodiments including plasticizers are preferred. The amount of such agents can be up to about 50 wt., 20 wt percent, 15 wt percent, 10 wt percent, 5 wt percent, 4 wt percent and/or at least 0.01 wt percent, 0.1 wt percent, 1 wt percent, or 5 wt, individually or collectively.

The plasticizer can include, but is not limited to, glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, polyether polyols, sorbitol, 2-methyl-1,3-propanediol, ethanolamines, and a mixture thereof. A preferred plasticizer is glycerin, sorbitol, triethyleneglycol, propylene glycol, diproyplene glycol, 2-methyl-1,3-propanediol, trimethylolpropane, or a combination thereof. The total amount of the plasticizer can be in a range of about 10 weight percent to about 40 wt., or about 15 weight percent to about 35 wt., or about 20 weight percent to about 30 wt., for example about 25 wt., based on total film weight. Combinations of glycerin, dipropylene glycol, and sorbitol can be used. Optionally, glycerin can be used in an amount of about 5 wt percent to about 30 wt, or 5 wt percent to about 20 wt, e.g., about 13 wt percent.

Optionally, dipropylene glycol can be used in an amount of about 1 weight percent to about 20 wt., or about 3 weight percent to about 10 wt., for example 6 weight percent. Optionally, sorbitol can be used in an amount of about 1 wt percent to about 20 wt, or about 2 wt percent to about 10 wt, e.g., about 5 wt percent. The specific amounts of plasticizers can be selected in a particular embodiment based on desired film flexibility and processability features of the water-soluble film. At low plasticizer levels, films may become brittle, difficult to process, or prone to breaking. At elevated plasticizer levels, films may be too soft, weak, or difficult to process for a desired use.

In a preferred embodiment the composition comprises a taste aversive such as denatonium benzoate and/or a pungent agent such as capsaicin.

Alternatively, a composition of the invention may be supplied in multidose plastics packs with a top or bottom closure. A dosing measure may be supplied with the pack either as a part of the cap or as an integrated system.

The following examples are provided to facilitate an understanding of the present invention. The examples are not provided to limit the scope of the claims.

### EXAMPLES

Examples 1-5 and Comparative Examples A-F demonstrate the effect of the weight ratio of alkoxylated glycerol ester to alkyl sulfate. Detergent compositions having various ratios of SOE-N-60 (alkoxylated glycerol ester) to sodium lauryl sulfate (SLS; alkyl sulfate) were prepared and their physical appearances were observed and recorded upon preparation as shown in Table 1.

Examples 1-5 all included SOE-N-60 and SLS in a weight ratio of at least 2:1. Comparative Examples A-F all included SOE-N-60 and SLS in a weight ratio below 2:1.

TABLE 1
Exemplary and Comparative detergent
compositions (components in wt %)

| | | | | Total | |
|---|---|---|---|---|---|
| Example | SOE-N-60 | SLS | Water | Surfactants | Appearance |
| 1 | 22 | 8 | 70 | 30 | Acceptable |
| 2 | 29.2 | 10.8 | 60 | 40 | Acceptable |
| 3 | 45 | 16.5 | 38.5 | 61.5 | Acceptable |
| 4 | 80 | 6 | 14 | 86 | Acceptable |
| 5 | 90 | 3 | 7 | 93 | Acceptable |
| A | 10 | 27 | 63 | 37 | Gel |
| B | 15 | 25.5 | 59.5 | 40.5 | Gel |
| C | 20 | 24 | 56 | 44 | Gel |
| D | 25 | 22.5 | 52.5 | 47.5 | Gel |
| E | 30 | 21 | 49 | 51 | Gel |
| F | 35 | 19.5 | 45.5 | 54.5 | Gel |

The physical appearances of the various detergent compositions were assessed qualitatively. A determination of whether the composition is acceptable is conducted. “Acceptable” in this case refers to an appearance of the composition in which all the phases are mixed and the composition has not formed a viscous gel, but is still of acceptably low viscosity such that it is pourable. All acceptable compositions have a weight ratio is being at least 2:1 (Examples 1-5). Where compositions formed a gel of high viscosity, the compositions are no longer pourable and this is considered to not be acceptable and the compositions are denoted “Gel” in Table 1.

The results show that the composition tends to gel upon mixing SOE-N-60 and SLS where the weight ratio of the two components is below 2:1 (Comparative Examples A-F).

### Comparative Examples G-J

Further comparative compositions were prepared which contained SOE-N-60 as alkoxylated glycerol ester, along with sodium ethoxylated alkyl ether sulfate (SLES 2EO; also known as sodium laureth-2 sulfate). The physical appearances of the compositions were observed and recorded upon preparation as shown in Table 2.

TABLE 2
Comparative detergent compositions (components in wt %)

| | | SLES | | Total | |
|---|---|---|---|---|---|
| Example | SOE-N-60 | 2EO | Water | Surfactants | Appearance |
| G | 29.2 | 10.8 | 60 | 40 | Gel |
| H | 45 | 16.5 | 38.5 | 61.5 | Gel |
| J | 80 | 6 | 14 | 86 | Gel |

Comparative Examples G, H and J may be compared directly with Examples 2, 3 and 4 respectively. It can be observed by the naked eye that Examples G-J formed a gel while Examples 2, 3 and 4 formed acceptable compositions.

Although the Example and respective Comparative Example in each case contained the same quantities of alkoxylated glycerol ester and secondary surfactant, the inventive examples containing SLS resulted in an acceptable physical appearance while the Comparative Examples containing SLES 2EO resulted in gelation.

1. A composition comprising from 30% to 100% by weight of a surfactant system which comprises:
a) an alkoxylated glycerol ester represented by the formula (I); 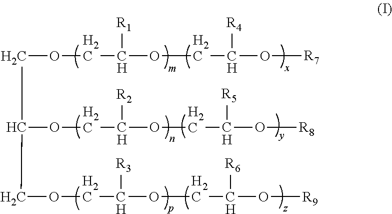
R₇=H, or —CO—R₁₀
R₈=H, or —CO—R₁₁
R₉=H, or —CO—R₁₂
where each of R₁ to R₆ is independently a hydrogen or a methyl group; each of R₇ to R₉ is independently a hydrogen, or an acyl group in which R₁₀, R₁₁, and R₁₂ is independently a linear or branched, alkyl or alkenyl group having 1 to 30 carbon atoms; m, n, p, x, y, and z are each independently a number from 0 to 30; the sum of m, n, p, x, y, z being in the range of 1 to 90; and
b) an alkyl sulfate;
wherein the weight ratio of the alkoxylated glycerol ester to the alkyl sulfate is from 2.5:1 to 50:1.

2. The composition according to claim 1, wherein each of R₁ to R₆ is hydrogen, and each of R₇ to R₉ is independently a hydrogen, or an acyl group in which R₁₀, R₁₁, and R₁₂ is independently a linear or branched, alkyl or alkenyl group having 1 to 30 carbon atoms.

3. The composition according to claim 1, wherein each of R₁ to R₆ is hydrogen, and each of R₇ to R₉ is an acyl group in which R₁₀, R₁₁, and R₁₂ is independently a linear alkyl group having 1 to 30 carbon atoms.

4. The composition according to claim 1, wherein m, n, p, x, y, and z are each independently a number from 1 to 25.

5. The composition according to claim 1, wherein the sum of m, n, p, x, y, z is in the range of 3 to 60.

6. The composition according to claim 1, wherein the alkoxylated glycerol ester comprises coconut oil ethoxylates, palm oil ethoxylates, palm kernel oil ethoxylates or mixtures thereof.

7. The composition according to claim 1, wherein the alkyl sulfate has an alkyl group having 8 to 18 carbon atoms.

8. The composition according to claim 1, wherein the alkyl sulfate comprises sodium, magnesium, ammonium or ethanolamine salts of alkyl sulfate having 8 to 18 carbon atoms.

9. The composition according to claim 1, wherein the weight ratio of the alkoxylated glycerol ester to the alkyl sulfate is from 3:1 to 40:1.

10. The composition according to claim 1, wherein the surfactant system is present in an amount from 35% to 95% by weight of the composition.

11. The composition according to claim 1, wherein the composition further comprises linear alkyl benzene sulfonates.

12. The composition according to claim 1, wherein the composition is a liquid detergent composition.

13. The composition according to claim 1, wherein the composition is in a unit dose format.

14. A method for forming a liquid detergent composition by dispersing a dose of the composition according to claim 1.

15. A method for forming a wash liquor by dispersing a dose of the composition according to claim 1.
